(19) United States
(12) Patent Application Publication
(10) Pub. No.: US 2006/0077066 A1
(43) Pub. Date: Apr. 13, 2006

(54) Electronic equipment

(75) Inventor: Mitsuaki Fujimori, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/241,566

(22) Filed: Sep. 30, 2005

(30) Foreign Application Priority Data
Oct. 4, 2004 (JP) 2004-290933

(51) Int. Cl. G08B 3/00; G08B 21/00

(52) U.S. Cl. 340/691.6; 340/654

(57) ABSTRACT

An electronic equipment has a housing, and a state display section which displays a state of the electronic equipment. The state display section is provided at an edge line portion of the housing. The housing has a concave portion at the edge line portion, and the state display section is provided at the concave portion.

### CROSS-REFERENCE TO RELATED APPLICATIONS

This application is based upon and claims the benefit of priority from the prior Japanese Patent Applications No. 2004-290933, filed on Oct. 4, 2004, the entire contents of which are incorporated herein by reference.

### BACKGROUND OF THE INVENTION

1. Field of the Invention

The present invention relates to an electronic equipment promoting a visibility of a display section and a degree of freedom of arranging a light source.

2. Description of the Related Art

The following document is referred to as a related art of an electronic equipment having a housing and a state display section.

User's Manual, No.: IM 34P02Q01-01 “STARDOM FCN/FCJ Manual” Aug. 28, 2002, second edition, page: A2-1, drawing FCJ (front view) issued by Yokokawa Electronic Corporation.

FIG. 17 is an explanative view of a configuration of an essential portion of a related art generally used.

In FIG. 17, a front face of a housing 1 of an electronic equipment is provided with a state display section 2.

In the equipment, three pieces of LED elements are used as the state display section 2, and signs of HRDY, RDY, CTRL are illustrated at sides of the respective LED elements.

Here, notation HRDY designates an abbreviation of HARDREADY, notation RDY designates an abbreviation of READY, and notation CTRL designates an abbreviation of CONTROL.

Meanwhile, high function formation and high speed formation of an electronic equipment increases kinds of display/operation of cables and the equipment for exchanging signals between the equipment and outside in accordance with progress of an electronic equipment, particularly, computer technology.

Further, whereas high function formation and high speed formation of electronic equipment increases a heat generation amount, heat radiation cooling causes an important technical problem by small-sized formation of an equipment, and an attitude of an equipment per se is frequently restricted for efficiently radiating heat in order to promote reliability in operation and life and preventing trouble of fire, explosion or the like.

On the other hand, small-sized formation of an equipment per se is progressed and an area of a surface of an equipment capable of being used in display or the like is firmly narrowing.

Further, high function formation and small-sized formation of an equipment significantly restrict not only an area of the surface of the equipment but also an arrangement per se of parts at inside of the equipment, an arrangement of interface with outside is rectified by mounting the parts at inside of the equipment and an attitude of the equipment per se in operation is frequently determined.

Therefore, it is general to constitute display of an equipment by conceiving a specified installing mode and further rigid formation is progressed in the installing mode of an equipment in operation.

In contrast to the progress of rigid formation of the attitude in operation by high function formation and small-sized formation of electronic equipment, roles borne thereby are diversified to control, communication, recording, display or the like, in addition thereto, a case of using electronic equipment per se to be integrated to other equipment in order to bear a portion of a function is increased, and a diversification of a request for an environment of using electronic equipment or a mode of installing electronic equipment is progressed.

Electronic equipment are obliged to deal with conflicting problems of the rigid formation of the installing mode and the diversification of needs by constituting a product lineup by a plurality of modes of an equipment having similar/resembling functions.

However, by preparing a plurality of products having similar functions, on the side of providing electronic equipment, not only an increase in development cost and control cost of sale and inventory and a risk of simultaneously holding a plurality of product kinds are naturally borne but also on a side of being provided with equipment, there is brought about a necessity of determining a mode of installing integrated equipment or equipment to be integrated at an initial stage of design/scheme of a system, and a change in a specification, a degree of freedom of designing, or reutilizing of once used equipment cannot flexibly be dealt with.

Further, according to electronic equipment conceived to be integrated, there is an example for promoting a degree of freedom with regard to attitude/direction of a proposed product for various mounting modes by providing only a mounting board in an electronic equipment as a part or a semiproduct.

Further, even when only a minimum function is provided as a part of a semiproduct, all of design with regard to exchange with outside is borne by a burden on the proposed side and basically, nothing is resolved.

### SUMMARY OF THE INVENTION

An object of the invention is to provide an equipment promoting a visibility of a display section and a degree of freedom of arranging a light source.

The invention provides an electronic equipment, having: a housing; and a state display section which displays a state of the electronic equipment, wherein the state display section is provided at an edge line portion of the housing.

In the electronic equipment, the housing has a concave portion at the edge line portion, and the state display section is provided at the concave portion.

In the electronic equipment, the edge line portion may be formed in a curve. In the electronic equipment, the edge line portion may be formed to be inclined.

The invention also provides an electronic equipment, having: a housing having a notch portion at a corner portion of the housing; and a state display section which displays a state of the electronic equipment, wherein the state display section is provided at the notch portion.

In the electronic equipment, the housing has a concave portion at an edge line portion of the notch portion, and the state display section is provided at the concave portion.

In the electronic equipments, the state display section has a light-emitting diode.

According to the electronic equipment, there is provided the electronic equipment not only capable of viewing the state display section from an upper skewed direction of the edge line of the electronic equipment but also capable of viewing a display state from normal line directions of two pieces of surfaces designing the edge line.

Therefore, the electronic equipment is capable of realizing to attach the single piece of the display portion constituting front faces respectively by the two pieces of the faces by a single light source.

Particularly, by diffusing light by a method of roughening a surface of the state display section or the like, there is provided the display portion of the electronic equipment capable of realizing to attach the single piece of the display portion constituting the front faces respectively by the two pieces of the faces by the single piece of the light source.

There is provided the display portion of the electronic equipment constituting the invention of widening a degree of freedom of a mode of installing the electronic equipment and capable of contributing to enlargement of a degree of freedom of design of an electronic equipment which is obliged to install in a specific attitude owing to, for example, a direction of connecting the cable or heat radiation of the electronic equipment.

Further, there is provided the display portion of the electronic equipment preferable for densely aggregating the state display sections to attach. Since functions of the respective state display sections can be displayed, there is provided the electronic equipment capable of easily confirming the functions of the respective state display sections.

According to the electronic equipment, there is provided the electronic equipment not only capable of viewing the state display section from an upper skewed direction of the corner of the electronic equipment but also capable of viewing a display state from normal line directions of three pieces of faces designing the corner.

Therefore, the electronic equipment is capable of realizing to install the single piece of the display portion constituting front faces respectively by the three pieces of the faces by a single light source.

Particularly, by diffusing light by a method of roughening a surface of the state display section or the like, there is provided the display portion of the electronic equipment capable of realizing to attach the single piece of the display portion constituting the front faces respectively by the three pieces of the faces by the single light source.

There is provided the display portion of the electronic equipment constituting the invention widening a degree of freedom of a mode of installing the electronic equipment and capable of contributing to enlargement of a degree of freedom of design of an electronic equipment which is obliged to be installed in a specific attitude owing to, for example, a direction of connecting a cable or heat radiation of the electronic equipment.

Further, there is provided the display portion of the electronic equipment preferable for densely aggregating the state display sections to attach. Since functions of the respective state display sections can be displayed, there is provided the electronic equipment capable of easily confirming the functions of the respective state display sections.

In the case that the light-emitting diode is used for the state display section, the display portion of the electronic equipment with small power consumption is provided.

### BRIEF DESCRIPTION OF THE DRAWINGS

FIG. 1 is an explanatory view of a configuration of an essential portion of a first embodiment according to the invention;

FIG. 2 is a view viewed from direction “A” of FIG. 1;

FIG. 3 is a view viewed from direction “B” of FIG. 1;

FIG. 4 is an explanatory view of a configuration of an essential portion of a second embodiment according to the invention;

FIG. 5 is a view viewed from direction “A” of FIG. 4;

FIG. 6 is a view viewed from direction “B” of FIG. 4;

FIG. 7 is an explanatory view of a configuration of an essential portion of a third embodiment according to the invention;

FIG. 8 is an explanatory view of a configuration of an essential portion of a fourth embodiment according to the invention;

FIG. 9 is an explanatory view of a configuration of an essential portion of a fifth embodiment according to the invention;

FIG. 10 is a view viewed from direction “A” of FIG. 9;

FIG. 11 is a view viewed from direction “B” of FIG. 9;

FIG. 12 is a view viewed from direction “C” of FIG. 9;

FIG. 13 is an explanatory view of a configuration of an essential portion of a sixth embodiment according to the invention;

FIG. 14 is a view viewed from direction “A” of FIG. 13;

FIG. 15 is a view viewed from direction “B” of FIG. 13;

FIG. 16 is a view viewed from direction “C” of FIG. 13; and

FIG. 17 is an explanatory view of a configuration of an essential portion of a related art which is generally used conventionally.

### DETAILED DESCRIPTION OF THE PREFERRED EMBODIMENTS

Embodiments of the invention will be explained in details with reference to the drawings as follows.

### First Embodiment

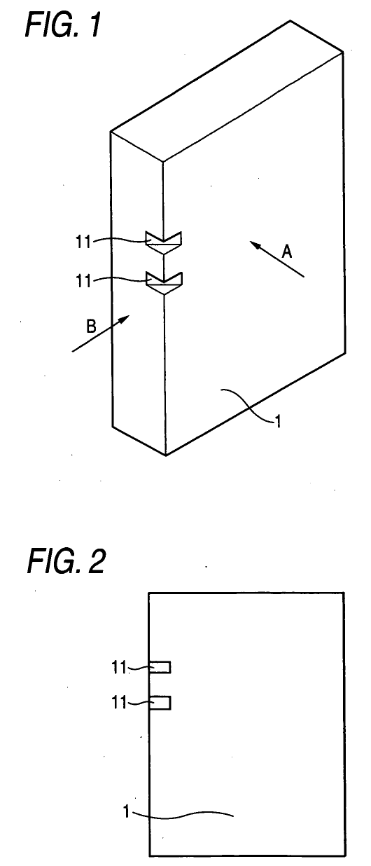

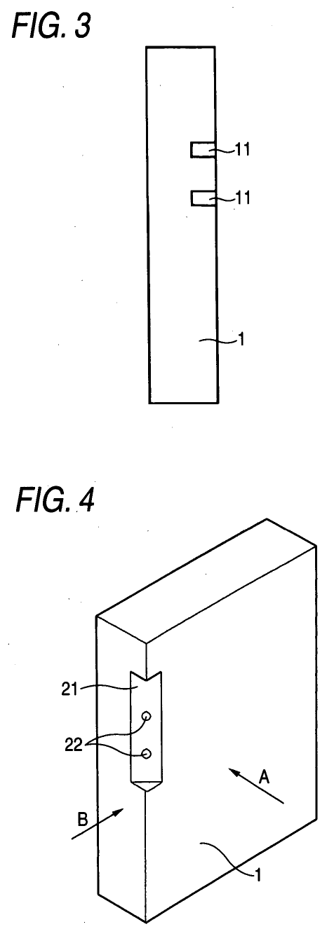

FIG. 1 is an explanatory view of a configuration of an essential portion of a first embodiment of the invention, FIG. 2 is a view viewed from direction “A” of FIG. 1, and FIG. 3 is a view viewed from direction “B” of FIG. 1.

A state display section 11 is provided by notching an edge line portion of a housing 1 of electronic equipment.

In this embodiment, as the state display section 11, a light-emitting diode is used.

As a result, there is provided the electronic equipment not only capable of viewing the state display section from an upper skewed direction of the edge line of the electronic equipment but also capable of viewing a display state from normal line directions A, B of two pieces of faces designing the edge line.

Therefore, the electronic equipment is capable of realizing to attach the single piece of a display portion respectively constituting front faces by the two pieces of the faces by a single light source.

Particularly, there is provided the electronic equipment capable of realizing to attach the single piece of the display portion constituting the respective front faces by the two pieces of the faces by the single light source by diffusing light by a method of roughening a surface of the state display section 11 or the like.

Although a function similar to the above-described can be realized by using a plurality of light sources, there is brought about a drawback of necessitating to ensure cost and a mounted region.

Further, in comparison with the configuration of dividing a single light source to two faces by a light guiding part to display simultaneously, it is not necessary to disperse a light amount and therefore, there is provided the electronic equipment without a difficulty of uniformly diving light which is restricted by an arrangement and a direction of an element constituting a light source and achieving an effect of capable of realizing high visibility in comparison with a case of using a light source having the same brightness.

There is provided the electronic equipment capable of widening a degree of freedom of a mode of installing the electronic equipment, and capable of contributing to enlargement of a degree of freedom of design of an electronic equipment which is obliged to be installed by a specific attitude by other factor for restricting the installing mode, for example, a direction of connecting a cable or heat radiation of the electronic equipment.

Further, the state display sections 11 can be provided to be proximate to each other and independently from each other and therefore, there is provided the electronic equipment preferable for densely aggregating the state display sections 11 to attach.

Since a light-emitting diode is used as the state display section 11, the electronic equipment with small power consumption can be provided.

### Second Embodiment

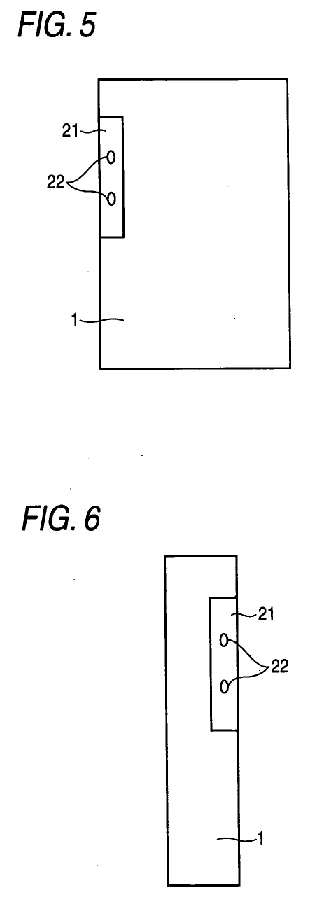

FIG. 4 is an explanatory view of a configuration of an essential portion of a second embodiment of the invention, FIG. 5 is a view viewing from direction “A” of FIG. 4, and FIG. 6 is a view viewing from direction “B” of FIG. 4.

A concave portion 21 is provided by notching an edge line portion of the housing 1 of the electronic equipment.

A state display section 22 is provided at a concave portion 21.

In this embodiment, a light-emitting diode is used for the state display section 22.

As a result, there is provided the electronic equipment not only capable of viewing the state display section 22 from an upper skewed direction of an edge line (normal line direction of inclined face) of the electronic equipment but also capable of viewing a display state from normal line directions of two pieces of faces A, B designing the edge line.

Therefore, the electronic equipment is provided with the electronic equipment capable of realizing to attach a single piece of the display portion constituting front faces respectively by the two pieces of faces A, B by a single light source.

Although a function similar to the above-described can be realized also by using a plurality of light sources, there is brought about a drawback of needing to ensure cost and a mounting region.

Further, in comparison with a configuration of dividing a single light source to two faces to simultaneously display by a light guiding part, it is not necessary to disperse a light amount and therefore, there is not a difficulty of dividing light uniformly, which is restricted by an arrangement and a direction of an element constituting a light source, further, in comparison with a case of using a light source having the same brightness, there is provided the electronic equipment achieving an effect of capable of realizing high visibility.

There is provided the electronic equipment constituting the invention widening a degree of freedom of a mode of installing the electronic equipment and also capable of contributing to enlargement of a degree of freedom of design of an electronic equipment which is obliged to be installed in a specific attitude owing to other factor of restricting an installing mode, for example, a direction of connecting a cable or heat radiation of the electronic equipment.

Further, at the concave portion 21, function signs of the respective state display sections 22 can be displayed and therefore, there is provided the electronic equipment capable of easily confirming the functions of the respective state display sections 22.

Since a light-emitting diode is used for the state display section 22, the electronic equipment with small power consumption can be provided.

### Third Embodiment

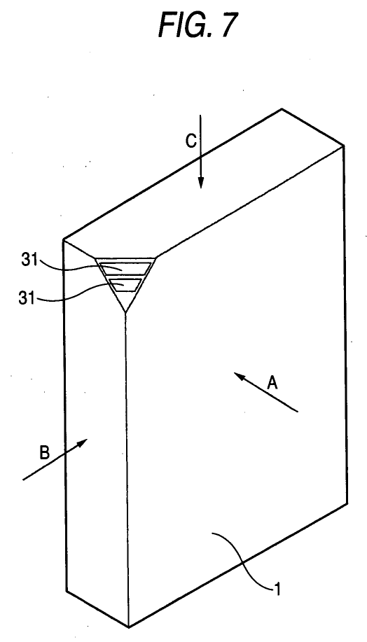

FIG. 7 is an explanatory view of a configuration of an essential portion of a third embodiment of the invention.

A state display section 31 is provided by notching a corner portion of the housing 1 of the electronic equipment.

In this embodiment, a light-emitting diode is used for the state display section 31.

As a result, there is provided the electronic equipment not only capable of viewing the state display section 31 from an upper skewed direction of the corner of the electronic equipment but also capable of viewing a display state also from normal line directions A, B, C of three pieces of faces designing the corner.

Therefore, the electronic equipment is provided with the electronic equipment capable of realizing to attach the single piece of the display portion constituting front faces respectively by the three pieces of faces by a single light source.

Particularly, there is provided the electronic equipment capable of realizing to attach the single piece of the display portion constituting front faces respectively by the three pieces of faces by a single light source by diffusing light by a method of roughening a surface of the inclined face portion of the state display section 31.

Although a function similar to the above-described can also be realized by using a plurality of light sources, there is brought about a drawback of needing to ensure cost and a mounting region.

Further, in comparison with a configuration of dividing a single light source into two faces by a light guiding part to simultaneously display, it is not necessary to disperse a light amount and therefore, there is not a difficulty of diving light uniformly, which is restricted by an arrangement and a direction of an element constituting the light source, further in comparison with a case of using a light source having the same brightness, there is provided the electronic equipment achieving an effect of capable of realizing high visibility.

There is provided the electronic equipment constituting the invention widening a degree of freedom of a mode of installing the electronic equipment and capable of contributing to enlargement of a degree of freedom of design of an electronic equipment which is obliged to be installed in a specific attitude owing to other factor of restricting the installing mode, for example, a direction of connecting a cable or heat radiation of the electronic equipment.

Further, there is provided the electronic equipment preferable for densely aggregating to attach the state display sections 31.

Since a light-emitting diode is used for the state display section 31, the electronic equipment with small power consumption is provided.

Further, there is provided the electronic equipment which is used in various arranging states although the number of displays does not need to increase excessively.

### Fourth Embodiment

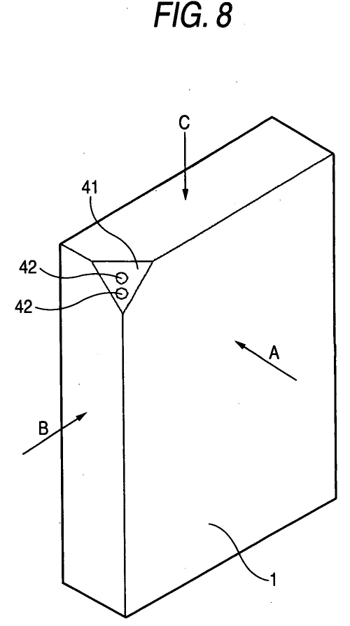

FIG. 8 is an explanatory view of a configuration of an essential portion of a fourth embodiment of the invention.

A notch portion 41 is provided by notching a corner portion of the housing 1 of the electronic equipment.

A state display section 42 is provided at the notch portion 41.

In this embodiment, a light-emitting diode is used for the state display section 42.

As a result, there is provided the electronic equipment not only capable of viewing the state display section from an upper skewed direction of the corner (inclined face normal line direction) of the electronic equipment but also capable of viewing a display state also from normal line directions A, B, C of three pieces of faces designing edge lines.

Therefore, the electronic equipment is provided with the electronic equipment capable of realizing to attach the single piece of the display portion constituting front faces respectively by the three pieces of faces by a single light source.

Although a function similar to the above-described can also be realized by using a plurality of light sources, there is brought about a drawback of needing to ensure cost and a mounting region.

Further, in comparison with the configuration, of dividing a single light source into two faces by a light guiding part to display simultaneously, it is not necessary to disperse a light amount and therefore, there is not a difficulty of diving light uniformly, which is restricted by an arrangement and a direction of an element constituting a light source, further, in comparison with a case of using a light source having the same brightness, there is provided the electronic equipment achieving an effect of capable of realizing high visibility.

There is provided the electronic equipment constituting the invention of widening a degree of freedom of a mode of installing the electronic equipment and also capable of contributing to enlargement of a degree of freedom of design of an electronic equipment which is obliged to be installed in a specific attitude owing to other factor of restricting the installing mode, for example, a direction of connecting a cable or heat radiation of the electronic equipment.

Further, function signs of respective state display sections can be displayed on a state display plate and therefore, there is provided the electronic equipment capable of easily confirming functions of the respective state display sections 42.

Since a light-emitting diode is used for the state display section 42, the electronic equipment with small power consumption is provided.

Further, there is provided the electronic equipment which is used in various arranging states, although the number of displays is not to increase excessively.

### Fifth Embodiment

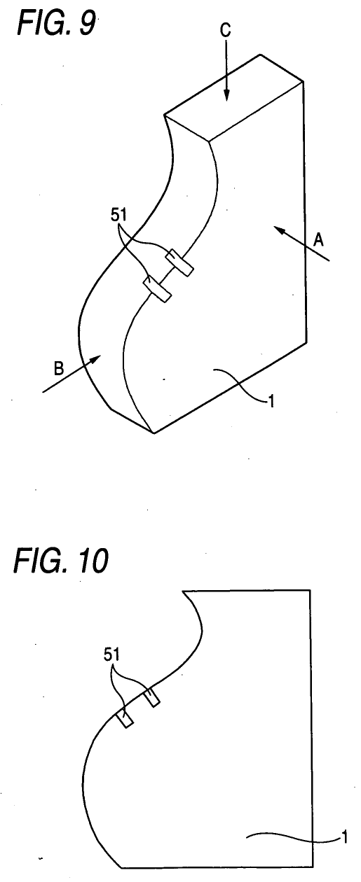

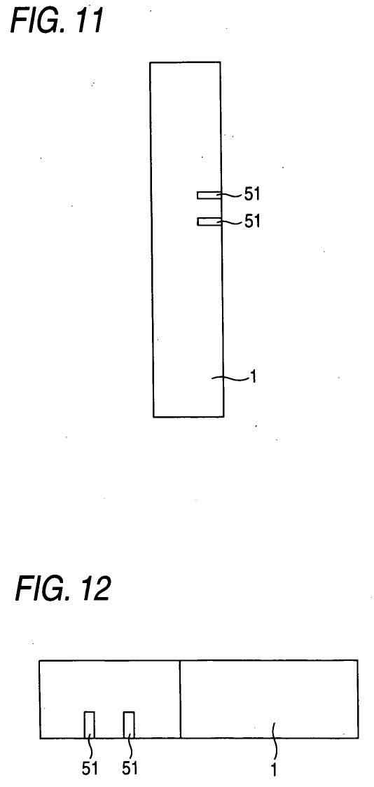

FIG. 9 is an explanatory view of a configuration of an essential portion of a fifth embodiment of the invention, FIG. 10 is a view viewed from direction “A” of FIG. 9, FIG. 11 is a view viewed from direction “B” of FIG. 9 and FIG. 12 is a view viewed from direction “C” of FIG. 9.

A state display section 51 is provided by notching an edge line portion of the housing 1 of the electronic equipment.

In this embodiment, the edge line portion of the housing 1 of the electronic equipment constitutes a curve.

In this embodiment, a light-emitting diode is used for the state display section 51.

As a result, there is provided the electronic equipment achieving an effect of capable of partially serving a function of an example of a case of being provided at a corner of the housing 1 of the electronic equipment as shown by the third embodiment of FIG. 7 in addition to an effect of the first embodiment of FIG. 1.

### Sixth Embodiment

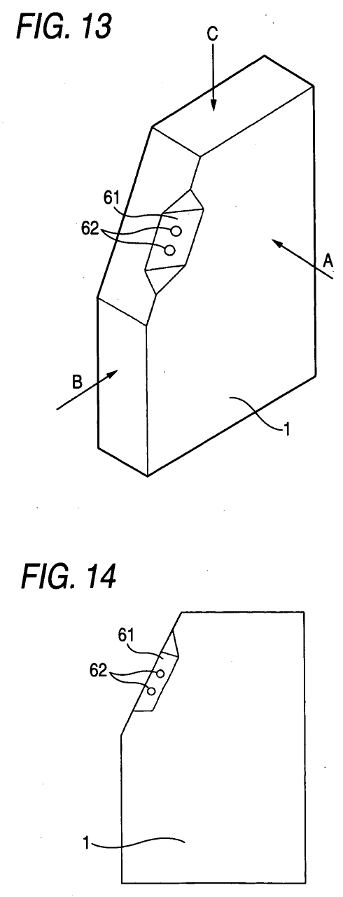

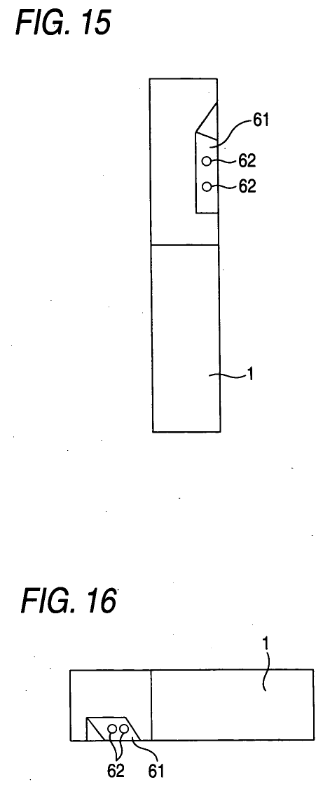

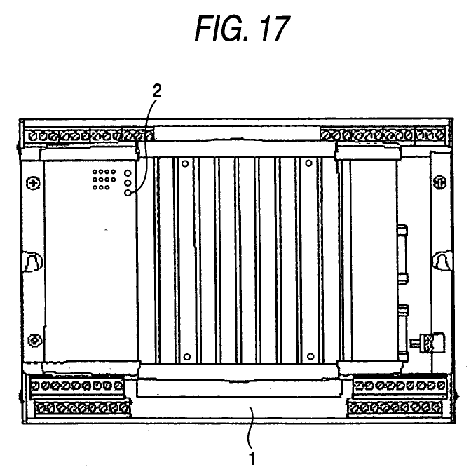

FIG. 13 is an explanatory view of a configuration of an essential portion of a sixth embodiment of the invention, FIG. 14 is a view viewed from direction “A” of FIG. 13, FIG. 15 is a view viewed from direction “B” of FIG. 13, and FIG. 16 is a view viewed from direction “C” of FIG. 13.

A concave portion 61 is provided by notching an edge line portion of the housing 1 of the electronic equipment.

In this embodiment, the edge line portion of the housing 1 of the electronic equipment constitutes an inclination.

A state display section 62 is provided at the concave portion 61.

In this embodiment, a light-emitting diode is used for the state display section 62.

As a result, there is provided the electronic equipment achieving an effect of capable of partially serving a function of an example of a case of being provided at a corner of the housing 1 of the electronic equipment as shown by the fourth embodiment of FIG. 8 in addition to an effect of the second embodiment of FIG. 4.

Further, the invention is not limited to a single display function but naturally may include a plurality of display portions.

Further, although the inclined face portion is indicated as a plane having angles of respective faces of the housing 1 of the electronic equipment equal to each other, it is not necessarily needed that the angles are equal to each other but a face deviated to any face will do. Further, the face does not need to be in complete plane but may naturally be a curved face.

Further, the above-described explanation only shows specific embodiments with an object of explanation and exemplification of the invention.

Therefore, the invention is not limited to the above-described embodiments but includes a number of changes and modifications within the range not deviated from an essence thereof.

What is claimed is:

1. An electronic equipment, comprising:
a housing; and
a state display section which displays a state of the electronic equipment,
wherein the state display section is provided at an edge line portion of the housing.

2. The electronic equipment according to claim 1,
wherein the housing has a concave portion at the edge line portion, and
the state display section is provided at the concave portion.

3. The electronic equipment according to claim 1,
wherein the edge line portion is formed in a curve.

4. The electronic equipment according to claim 2,
wherein the edge line portion is formed to be inclined.

5. An electronic equipment, comprising:
a housing having a notch portion at a corner portion of the housing; and
a state display section which displays a state of the electronic equipment,
wherein the state display section is provided at the notch portion.

6. The electronic equipment according to claim 5,
wherein the housing has a concave portion at an edge line portion of the notch portion, and
the state display section is provided at the concave portion.

7. The electronic equipment according to claim 1,
the state display section has a light-emitting diode.

8. The electronic equipment according to claim 5,
the state display section has a light-emitting diode.
